(19) United States
(12) Patent Application Publication
(10) Pub. No.: US 2021/0070291 A1
(43) Pub. Date: Mar. 11, 2021

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Kaijiang Yu, Wako-shi (JP)

(21) Appl. No.: 17/012,123

(22) Filed: Sep. 4, 2020

(30) Foreign Application Priority Data
Sep. 9, 2019 (JP) 2019-163789

(51) Int. Cl. B60W 30/16; B60W 40/107

(52) U.S. Cl. CPC B60W 30/162; B60W 40/107; B60W 2520/105; B60W 2554/4045; B60W 2554/4041; B60W 2554/4049; B60W 2552/10

(57) ABSTRACT

A vehicle control device includes an acquirer configured to acquire a recognition result of a recognizer for recognizing surroundings of a vehicle and an action controller configured to control an action of the vehicle. When the recognition result represents that a first vehicle traveling immediately in front of the vehicle has been recognized and a second vehicle traveling immediately in front of the first vehicle has not been recognized, the action controller causes the vehicle to track the first vehicle with first acceleration derived in a first rule. When the recognition result represents that the first vehicle and the second vehicle have been recognized, the action controller causes the vehicle to track the first vehicle with second acceleration derived in a second rule. The second rule is a rule for deriving acceleration less than that in the first rule when a relative relationship between the vehicle and the first vehicle is uniform.

### CROSS-REFERENCE TO RELATED APPLICATION

Priority is claimed on Japanese Patent Application No. 2019-163789, filed Sep. 9, 2019, the content of which is incorporated herein by reference.

### BACKGROUND

### Field of the Invention

The present invention relates to a vehicle control device, a vehicle control method, and a storage medium.

### Description of Related Art

Conventionally, a vehicle traveling control device for identifying a tracked preceding vehicle that is traveling in front of a host vehicle and is required to be tracked by the host vehicle and calculating target acceleration of the host vehicle required to maintain an inter-vehicle distance between the host vehicle and the tracked preceding vehicle at a predetermined first target inter-vehicle distance as tracking target acceleration has been disclosed (Japanese Unexamined Patent Application, First Publication No. 2017-202742). This vehicle traveling control device adopts second acceleration less than first acceleration as final target acceleration when a specific condition in which there is another vehicle traveling in an overtaking lane and traveling in front of the host vehicle at a point in time when a direction indicator has been operated to indicate a lane change to the overtaking lane is satisfied and a speed of the other vehicle at the point in time when the direction indicator has been operated is determined to be less than or equal to a speed of the host vehicle at the point in time when the direction indicator has been operated.

### SUMMARY

However, the presence of another vehicle traveling in an overtaking lane and traveling in front of a host vehicle is taken into account in the conventional technology, but a vehicle present in front of the above-described other vehicle is not taken into account. Thus, the vehicle may not be able to implement appropriate control according to a surrounding environment.

The present invention has been made in view of such circumstances and an objective of the present invention is to provide a vehicle control device, a vehicle control method, and a storage medium capable of implementing more appropriate control of a vehicle according to a surrounding environment.

A vehicle control device, a vehicle control method, and a storage medium according to the present invention adopt the following configurations.

(1): According to an aspect of the present invention, there is provided a vehicle control device including: an acquirer configured to acquire a recognition result of a recognizer for recognizing surroundings of a vehicle; and an action controller configured to control an action of the vehicle, wherein, when the recognition result represents that a first vehicle traveling immediately in front of the vehicle has been recognized and a second vehicle traveling immediately in front of the first vehicle has not been recognized, the action controller causes the vehicle to track the first vehicle with first acceleration derived in a first rule, wherein, when the recognition result represents that the first vehicle and the second vehicle have been recognized, the action controller causes the vehicle to track the first vehicle with second acceleration derived in a second rule, and wherein the second rule is a rule for deriving acceleration less than that in the first rule when a relative relationship between the vehicle and the first vehicle is uniform.

(2): In the above-described aspect (1), the relative relationship includes an inter-vehicle distance between the vehicle and the first vehicle and relative speeds of the vehicle and the first vehicle.

(3): In the above-described aspect (1), when the recognition result represents that the first vehicle and the second vehicle have been recognized and when the recognition result represents that the second vehicle has moved from a first road on which the vehicle is traveling to a second road adjacent to the first road or when it is predicted that the second vehicle will move from the first road to the second road on the basis of the recognition result, the action controller causes the vehicle to track the first vehicle with the second acceleration.

(4): In the above-described aspect (1), when the recognition result represents that the first vehicle has moved from a first road on which the vehicle is traveling to a second road adjacent to the first road or it is predicted that the first vehicle will move from the first road to the second road on the basis of the recognition result, the action controller causes the vehicle to track the first vehicle with the second acceleration.

(5): In the above-described aspect (3), the action controller predicts a movement direction of the first vehicle or the second vehicle on the basis of an ON state of a direction indicator of the first vehicle or the second vehicle and determines acceleration of the vehicle on the basis of a prediction result.

(6): In the above-described aspect (1), when the recognition result represents that the first vehicle has been recognized and the second vehicle has not been recognized if the vehicle moves from a first road on which the vehicle is traveling to a second road adjacent to the first road, the action controller causes the vehicle to track the first vehicle with the second acceleration.

(7): In the above-described aspect (1), a first specific area through which vehicles cannot pass, a second specific area through which the vehicles can pass, and a third specific area through which the vehicles cannot pass provided between a first road and a second road adjacent to the first road in a width direction are provided in that order in a road extension direction, the vehicle traveling on the first road can travel on the second road by passing through the first specific area and the second specific area, and the vehicle traveling on the second road can travel on the first road by passing through the first specific area and the second specific area. The action controller causes the vehicle to track the first vehicle with the second acceleration when it is predicted that the vehicle, the first vehicle, and the second vehicle will move to the second road by passing through the second specific area, or that the vehicle will move to the second road and the first vehicle and the second vehicle will move to the second road, in a state in which the vehicle, the first vehicle, and the second vehicle are traveling on the first road with reference to the recognition result.

(8): In the above-described aspect (1), the second rule is a rule for determining corrected acceleration as the second acceleration by performing correction for curbing the first acceleration on the basis of an amount of change in a speed or acceleration of the vehicle during a predetermined time period in which the vehicle has traveled with the first acceleration.

(9): According to an aspect of the present invention, there is provided a vehicle control device including: an acquirer configured to acquire a recognition result of a recognizer for recognizing surroundings of a vehicle; and an action controller configured to control an action of the vehicle, wherein, when the recognition result represents that a first vehicle traveling immediately in front of the vehicle has been recognized and a second vehicle traveling immediately in front of the first vehicle has not been recognized, the action controller controls the vehicle on the basis of first acceleration derived in a first rule, wherein, when the recognition result represents that the first vehicle and the second vehicle have been recognized, the action controller controls the vehicle on the basis of second acceleration derived in a second rule, and wherein the second rule is a rule for deriving the second acceleration less than the first acceleration derived in the first rule on the basis of an amount of change in a speed or acceleration of the vehicle during a predetermined time period in which the vehicle has traveled with the first acceleration.

(10): According to an aspect of the present invention, there is provided a vehicle control method including: acquiring, by a computer, a recognition result of a recognizer for recognizing surroundings of a vehicle; controlling, by the computer, an action of the vehicle; when the recognition result represents that a first vehicle traveling immediately in front of the vehicle has been recognized and a second vehicle traveling immediately in front of the first vehicle has not been recognized, causing, by the computer, the vehicle to track the first vehicle with first acceleration derived in a first rule; and when the recognition result represents that the first vehicle and the second vehicle have been recognized, causing, by the computer, the vehicle to track the first vehicle with second acceleration derived in a second rule, wherein the second rule is a rule for deriving acceleration less than that in the first rule when a relative relationship between the vehicle and the first vehicle is uniform.

(11): According to an aspect of the present invention, there is provided a storage medium storing a program for causing a computer to: acquire a recognition result of a recognizer for recognizing surroundings of a vehicle; control an action of the vehicle; when the recognition result represents that a first vehicle traveling immediately in front of the vehicle has been recognized and a second vehicle traveling immediately in front of the first vehicle has not been recognized, perform a process of causing the vehicle to track the first vehicle with first acceleration derived in a first rule; and when the recognition result represents that the first vehicle and the second vehicle have been recognized, perform a process of causing the vehicle to track the first vehicle with second acceleration derived in a second rule, wherein the second rule is a rule for deriving acceleration less than that in the first rule when a relative relationship between the vehicle and the first vehicle is uniform.

According to the above-described aspects (1) to (11), it is possible to implement more appropriate control of a vehicle according to a surrounding environment.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram (part 1) for describing specific control.

FIG. 4 is a diagram (part 2) for describing specific control.

FIG. 5 is a diagram (part 3) for describing specific control.

FIG. 6 is a diagram (part 1) showing an example of an action of a vehicle in a comparative example.

FIG. 7 is a diagram (part 2) showing an example of an action of a vehicle in a comparative example.

FIG. 8 is a diagram for describing a process of a vehicle when another vehicle has not been recognized.

FIG. 9 is a diagram showing an example of acceleration.

FIG. 10 is a diagram showing another example of acceleration.

FIG. 11 is a diagram showing an example of a result of executing specific control and a result of executing a process of a comparative example.

FIG. 12 is a flowchart showing an example of a flow of a process executed by an automated driving control device.

FIG. 13 is a diagram showing an example of a functional configuration of a vehicle system according to a second embodiment.

FIG. 14 is a diagram for describing control of a vehicle according to the second embodiment.

FIG. 15 is a diagram showing an example of a functional configuration of a vehicle control system.

FIG. 16 is a diagram showing an example of a hardware configuration of an automated driving control device according to an embodiment.

### DESCRIPTION OF EMBODIMENTS

Hereinafter, embodiments of a vehicle control device, a vehicle control method, and a storage medium according to the present invention will be described with reference to the drawings.

### First Embodiment

### [Overall Configuration]

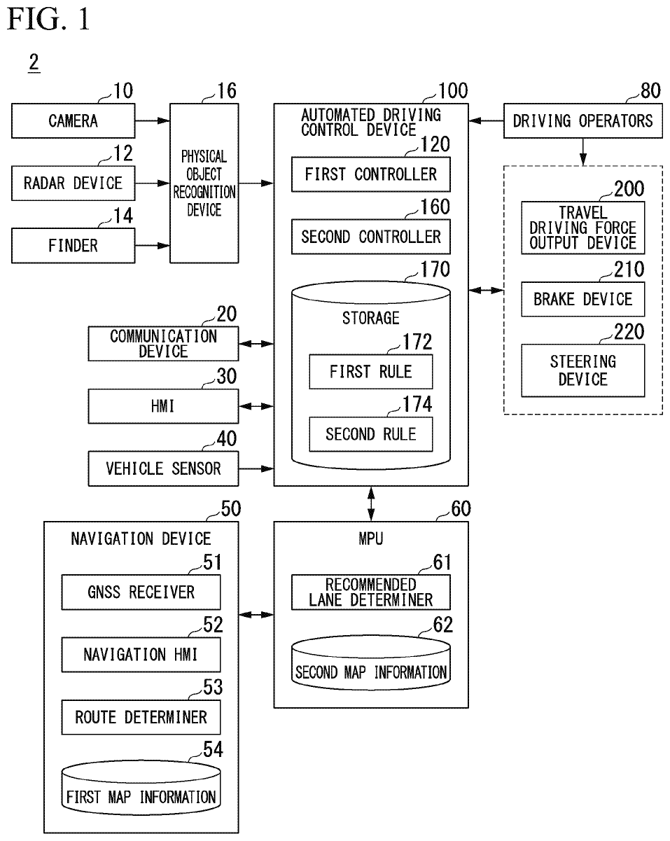

FIG. 1 is a configuration diagram of a vehicle system 2 using a vehicle control device according to an embodiment. For example, a vehicle in which the vehicle system 2 is mounted is a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power generated by an electric power generator connected to the internal combustion engine or electric power with which a secondary cell or a fuel cell is discharged.

For example, the vehicle system 2 includes a camera 10, a radar device 12, a finder 14, a physical object recognition device 16, a communication device 20, a human machine interface (HMI) 30, a vehicle sensor 40, a navigation device 50, a map positioning unit (MPU) 60, driving operators 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and parts of the configuration may be omitted or other configurations may be further added.

For example, the camera 10 is a digital camera using a solid-state imaging element such as a charge coupled device (CCD) or a complementary metal oxide semiconductor (CMOS). The camera 10 is attached to any location on the vehicle (hereinafter referred to as a host vehicle M) in which the vehicle system 2 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any location on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any location on the host vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 2.

The communication device 20 communicates with another vehicle present in the vicinity of the host vehicle M, or communicates with various types of server devices via a radio base station, using, for example, a cellular network or a Wi-Fi network, Bluetooth (registered trademark), dedicated short range communication (DSRC), or the like.

The HMI 30 presents various types of information to an occupant of the host vehicle M and receives an input operation by the occupant. The HMI 30 includes various types of display devices, a speaker, a buzzer, a touch panel, a switch, keys and the like.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. The recommended lane determiner 61 determines in what lane numbered from the left the vehicle will travel. The recommended lane determiner 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, telephone number information, and the like. The second map information 62 may be updated at any time when the communication device 20 communicates with another device.

For example, the driving operators 80 include an accelerator pedal, a brake pedal, a shift lever, a steering wheel, a steering wheel variant, a joystick, and other operators. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The automated driving control device 100 includes, for example, a first controller 120, a second controller 160, and a storage 170. Each of the first controller 120 and the second controller 160 is implemented, for example, by a hardware processor such as a central processing unit (CPU) executing a program (software). Some or all of these components are implemented by hardware (a circuit including circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the automated driving control device 100 or may be stored in a removable storage medium such as a DVD or a CD-ROM and installed in the HDD or the flash memory of the automated driving control device 100 when the storage medium (the non-transitory storage medium) is mounted in a drive device. The storage 170 is, for example, a storage device such as an HDD or a flash memory. The storage 170 stores a first rule 172 (information about a first rule) and a second rule 174 (information about a second rule). The first rule 172 and the second rule 174 are information which is referred to by a determiner 152. The first rule 172 and the second rule 174 will be described below. The automated driving control device 100 is an example of a “vehicle control device” and the combination of an action plan generator 140 and the second controller 160 is an example of an “action controller.”

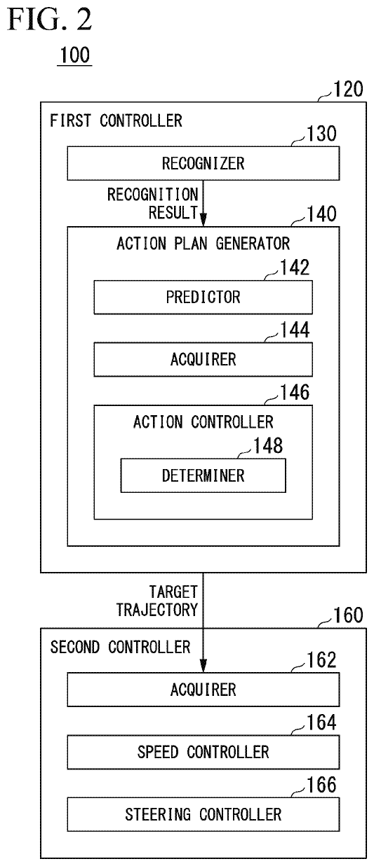

FIG. 2 is a functional configuration diagram of the first controller 120 and the second controller 160. The first controller 120 includes, for example, a recognizer 130, and the action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is ensured.

The recognizer 130 recognizes states of a position, a speed, acceleration, and the like of a physical object around the host vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

The action plan generator 140 generates a future target trajectory along which the host vehicle M is allowed to automatedly travel (independently of a driver's operation) in the traveling aspect defined by the event so that the host vehicle M can generally travel in the recommended lane determined by the recommended lane determiner 61 and further cope with a surrounding situation of the host vehicle M. For example, the target trajectory includes a speed element. For example, the target trajectory is represented by sequentially arranging points (trajectory points) at which the host vehicle M is required to arrive. The trajectory point is a point at which the host vehicle M is required to arrive for each predetermined traveling distance (for example, about several meters [m]). On the other hand, a target speed and target acceleration for each predetermined sampling time period (for example, about several tenths of a second [sec]) are generated as parts of the target trajectory. The trajectory point may be a position at which the host vehicle M is required to arrive at the sampling time for each predetermined sampling time period. In this case, information of the target speed or the target acceleration is represented by an interval between trajectory points.

The action plan generator 140 may set an automated driving event when the target trajectory is generated. Automated driving events include a constant-speed traveling event, a low-speed tracking traveling event, a lane change event, a branching event, a merging event, a takeover event, and the like. The action plan generator 140 generates a target trajectory according to an activated event. For example, the action plan generator 140 generates the target trajectory in consideration of a processing result of the action controller 146 to be described below when the target trajectory is generated. The target trajectory is a trajectory to which the acceleration determined by the determiner 148 is applied.

The action plan generator 140 includes, for example, a predictor 142, an acquirer 144, and an action controller 146. The predictor 142 predicts a future position of another vehicle present around the vehicle M on the basis of a recognition result of the recognizer 130. The acquirer 144 acquires a current position of the other vehicle recognized by the recognizer 130 from the recognizer 130 and acquires a future position of the other vehicle predicted by the predictor 142 from the predictor 142. The acquirer 144 may communicate with another vehicle different from the vehicle M to acquire predetermined information from the other vehicle. The predetermined information is, for example, information such as a direction in which the other vehicle is traveling, a route, and an intention of making a lane change.

The action controller 146 controls the action of the vehicle on the basis of information acquired by the acquirer 144. The action controller 146 includes, for example, a determiner 148. The determiner 148 determines acceleration of the vehicle M. Details of the processes of the action controller 146 and the determiner 148 will be described below. The action controller in the claims may include the predictor 142 in addition to the action controller 146.

The second controller 160 controls the travel driving force output device 200, the brake device 210, and the steering device 220 so that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information of a target trajectory (trajectory points) generated by the action plan generator 140 and causes a memory (not shown) to store the acquired information. The speed controller 164 controls the travel driving force output device 200 or the brake device 210 on the basis of speed elements associated with the target trajectory stored in the memory. The steering controller 166 controls the steering device 220 in accordance with a level of curvature of the target trajectory stored in the memory. For example, processes of the speed controller 164 and the steering controller 166 are implemented by a combination of feed-forward control and feedback control. As an example, the steering controller 166 executes feed-forward control according to the curvature of the road in front of the host vehicle M and feedback control based on deviation from the target trajectory in combination.

The travel driving force output device 200 outputs a travel driving force (torque) for enabling the vehicle to travel to driving wheels. For example, the travel driving force output device 200 may include a combination of an internal combustion engine, an electric motor, a transmission, and the like, and a power electronic control unit (ECU) that controls the internal combustion engine, the electric motor, the transmission, and the like. The ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operators 80 to the cylinder via a master cylinder as a backup. The brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operator 80 to cause the direction of the steerable wheels to be changed.

### [Outline of Specific Control]

The action controller 146 causes the vehicle M to track a first vehicle with first acceleration derived in the first rule 172 when a recognition result acquired by the acquirer 144 represents that the first vehicle traveling immediately in front of the vehicle M has been recognized and a second vehicle traveling immediately in front of the first vehicle has not been recognized and causes the vehicle M to track the first vehicle with second acceleration derived in the second rule 174 when the recognition result acquired by the acquirer 144 represents that the first vehicle and the second vehicle have been recognized. The second rule 174 is a rule for deriving the second acceleration less than the first acceleration derived in the first rule 172 when a relative relationship between the vehicle M and the first vehicle has the same conditions. Hereinafter, this control may be referred to as “specific control.” The first rule 172 and the second rule 174 will be described in [Acceleration determination technique] to be described below. The “relative relationship” includes an inter-vehicle distance between the vehicle M and the first vehicle and relative speeds of the vehicle M and the first vehicle.

### [Specific Control]

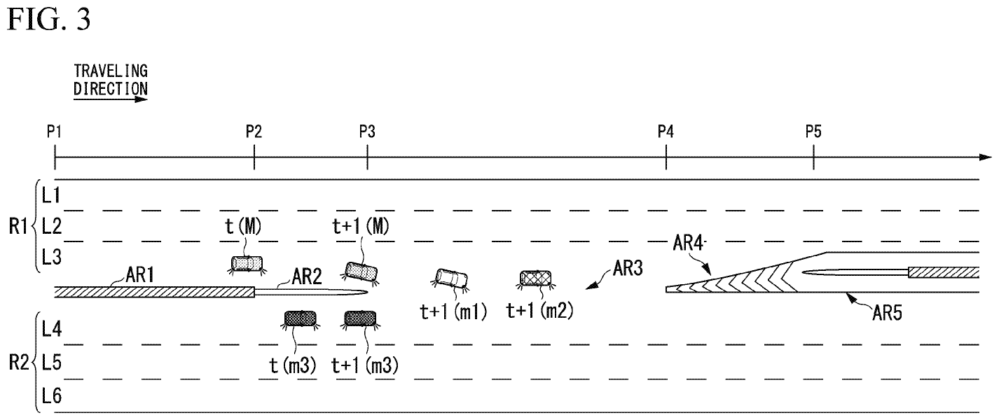

FIG. 3 is a diagram (part 1) for describing the specific control. Vehicles traveling on a first road R1 and a second road R2 travel in the same direction. The vehicle travels from a position P1 to a position P5 in FIG. 3. In FIG. 3, a road environment in which the first road R1 and the second road R2 meet is shown. The first road R1 and the second road R2 are roads that do not disappear as in a merge road. The first road R1 and the second road R2 extend, for example, from the position P5 by a predetermined distance (several hundred meters or several kilometers) or more.

A first area AR1, a second area AR2, a third area AR3, a fourth area AR4, and a fifth area ARS are present between the first road R1 and the second road R2 in a road width direction. The first area AR1 or the second area AR2 is an example of a “first specific area,” the third area AR3 is an example of a “second specific area,” and the fourth area AR4 or the fifth area ARS is an example of a “third specific area.”

The first area AR1 is an area between the position P1 and the position P2 and is an area for separating the first road R1 and the second road R2. A physical object having a predetermined height or more is provided in the first area AR1. The vehicle M traveling on the first road R1 cannot recognize a state of the second road R2 over the first area AR1. The second area AR2 is an area between the position P2 and the position P3 and is an area for separating the first road R1 and the second road R2. The vehicle M traveling on the first road R1 can recognize a state of the second road R2 over the second area AR2.

The third area AR3 is an area between the position P3 and the position P4. The third area AR3 is an area where a vehicle traveling on the first road R1 can move to the second road R2 or an area where a vehicle traveling on the second road R2 can move to the first road RE The fourth area AR4 is an area between the position P4 and the position P5 and is a flow guiding area for guiding the vehicle in the traveling direction. The fifth area ARS is an area where the position P5 is provided as a starting point and is an area for separating the first road R1 and the second road R2.

The first road R1 includes, for example, a lane L1, a lane L2, and a lane L3. The second road R2 includes, for example, a lane L4, a lane L5, and a lane L6. For example, the vehicle M can move from the first road R1 to the second road R2 by making a lane change from the lane L3 to the lane L4 in the third area AR3. For example, it is assumed that the vehicle M moves from the first road R1 to the second road R2.

At time t, it is assumed that the vehicle M is traveling near the position P2 in the lane L3. In the lane L3, it is assumed that there are another vehicle m1 traveling immediately in front of the vehicle M and another vehicle m2 traveling immediately in front of the other vehicle m1. The other vehicle m1 is a vehicle present within a predetermined distance from the vehicle M and the other vehicle m2 is a vehicle present within a predetermined distance from the other vehicle m1. The other vehicle m1 and the other vehicle m2 are vehicles scheduled to make a lane change to the lane L4. In the lane L4, there is another vehicle m3 traveling in front of the vehicle M in the traveling direction.

For example, at time t, the action controller 146 determines that the vehicle M is allowed to overtake the other vehicle m3 and move in front of the other vehicle m3 when the vehicle M is estimated to be able to overtake the other vehicle m3 and move in front of the other vehicle m3 with a predetermined degree of margin on the basis of positions and actions (for example, speeds and accelerations) of the other vehicles m1, m2, and m3. For example, the predictor 142 predicts future positions of the other vehicles m1, m2, and m3 or a position at which the vehicle M can arrive in the future on the basis of current positions and actions of the other vehicles and a predetermined model.

The action controller 146 determines whether or not to control the vehicle M so that the vehicle M overtakes the other vehicle m3 on the basis of a prediction result of the predictor 142. For example, when it is determined that the vehicle M will overtake the other vehicle m3 up to a predetermined point in the third area AR3 on the basis of the prediction result, the action controller 146 controls the vehicle M so that the vehicle M overtakes the other vehicle m3.

For example, the determiner 148 determines acceleration A as the acceleration of the vehicle M when the other vehicle m1 and the other vehicle m2 have been recognized as shown in FIG. 3. The action controller 146 causes the vehicle M to travel on the basis of the acceleration A. A technique of deriving the acceleration A (the second acceleration) will be described below. The specific control may be executed when a target vehicle has not been recognized or the specific control may be executed regardless of whether or not a target vehicle is to be overtaken even if the target vehicle has been recognized.

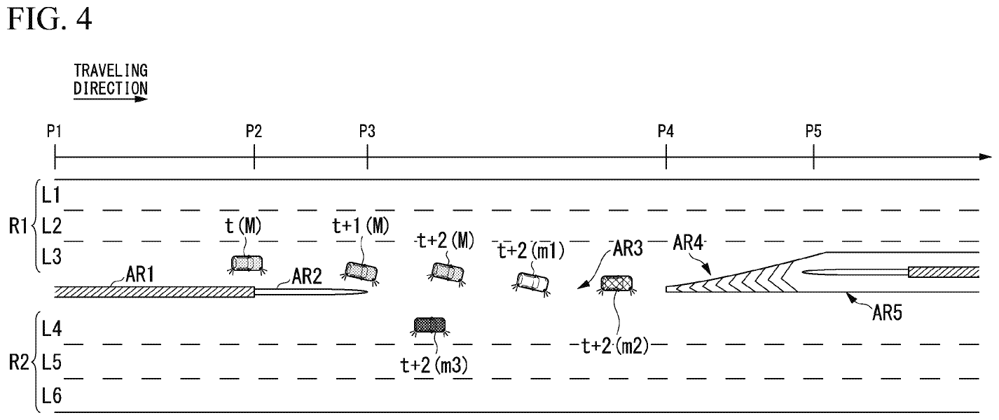

FIG. 4 is a diagram (part 2) for describing the specific control. At time t+1, when the vehicle M has reached the vicinity of the position P3 while moving with the acceleration A, the determiner 148 determines to maintain the acceleration A (or the second acceleration based on the second rule) if the state in which the other vehicle m2 is traveling immediately in front of the other vehicle m1 is maintained (if the vehicle M has recognized the other vehicle m2). At time t+2, the vehicle M is present at a position where the vehicle M has overtaken the other vehicle m3 or at a position where the vehicle M is traveling parallel to the other vehicle m3. In the example of FIG. 4, because a direction indicator of the vehicle M indicates a signal for entering the lane L4, the other vehicle m3 has started a lane change to the lane L5 so as to give way to the vehicle M.

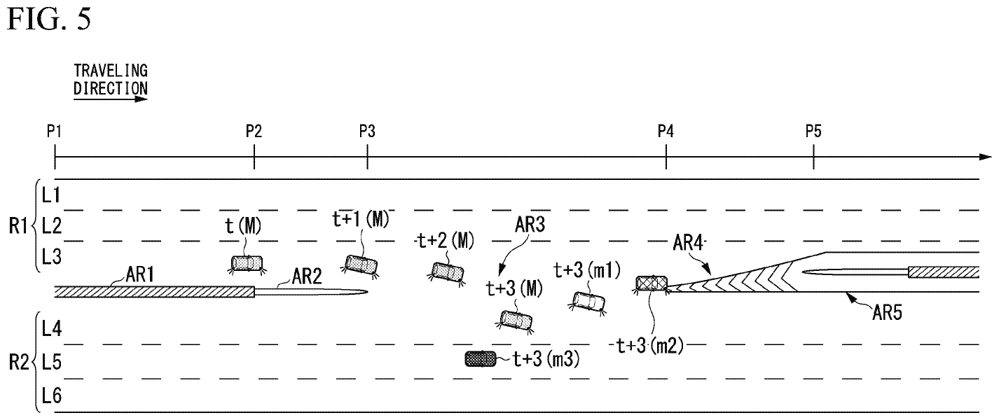

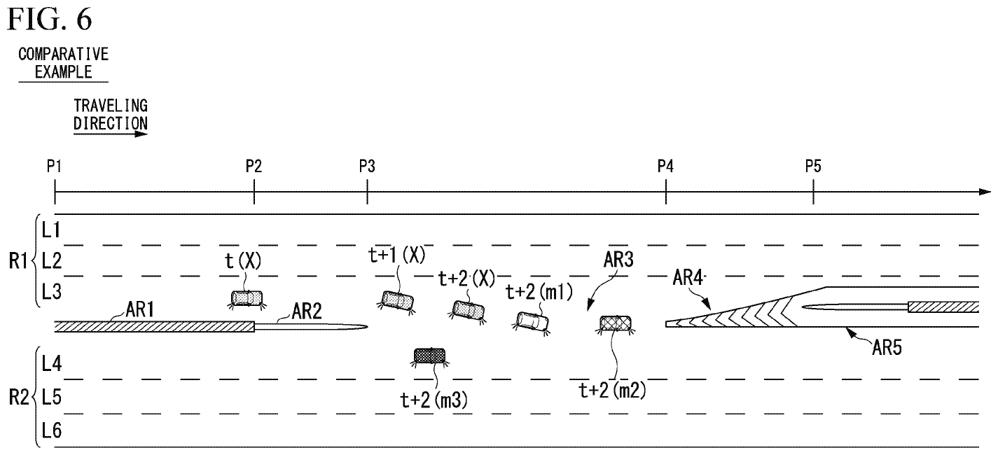

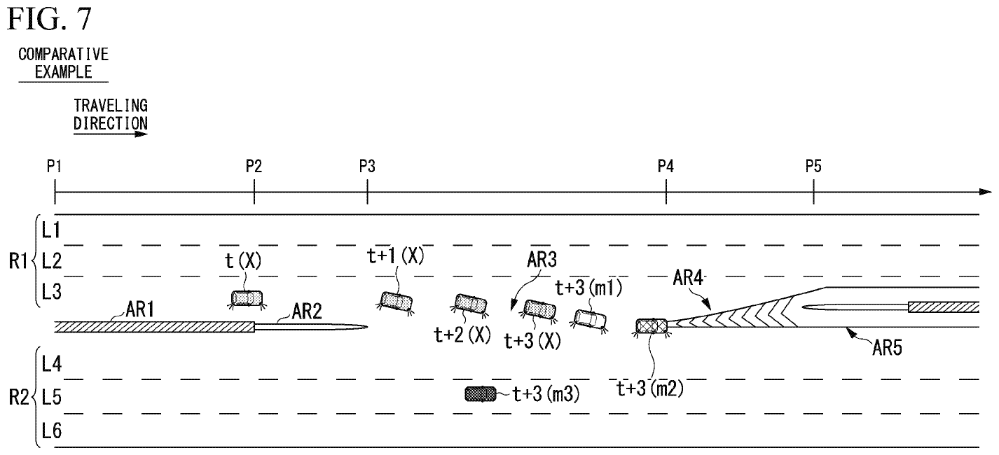

FIG. 5 is a diagram (part 3) for describing the specific control. At time t+3, the action controller 146 causes the vehicle M to enter the lane L4. As described above, the action controller 146 can cause the vehicle M to enter the second road R2 more smoothly than in comparative examples of FIGS. 6 and 7 to be described below by controlling the vehicle M on the basis of the acceleration A.

The determiner 148 causes the vehicle M to accelerate with acceleration (the acceleration A) less than acceleration of the comparative example (the first acceleration based on the first rule) between time t and time t+2. As a result, the inter-vehicle distance between the vehicle M and the other vehicle m1 becomes larger than the inter-vehicle distance of the comparative example. When the inter-vehicle distance increases in this manner, the vehicle M can take an appropriate action according to a change even if the action of the other vehicle m1 changes due to the action of the other vehicle m2.

For example, as shown in FIG. 5, when the other vehicle m2 misses a timing of entry into the lane L4 and decelerates or stops near the position P4, the other vehicle m1 may decelerate or stop due to the action of the other vehicle m2. In this case, because the vehicle M also accelerates with the acceleration A and maintains an appropriate inter-vehicle distance, the vehicle M can enter the second road R2 without being affected by the actions of the other vehicles m1 and m2.

After entering the second road R2, the vehicle M can take an action (for example, deceleration or passing) so that the other vehicle m1 or the other vehicle m2 can enter the lane L4 in consideration of the intention of the other vehicle m1 or the other vehicle m2.

Further, the vehicle M can overtake the other vehicle m3 by accelerating with the acceleration A at time t. Thus, the vehicle M moves in front of the other vehicle m3 or the other vehicle m3 makes a lane change to the lane L5, so that the vehicle M can smoothly and quickly enter the second road R2.

### Comparative Examples

FIG. 6 is a diagram (part 1) showing an example of an action of a vehicle in the comparative example. Differences from FIGS. 3 to 5 will be mainly described. At time t, when it is estimated that a vehicle X in the comparative example can overtake another vehicle m3 and move in front of the other vehicle m3 on the basis of positions and actions (for example, speeds and accelerations) of another vehicle m1, another vehicle m2, and the other vehicle m3, a process of causing the vehicle X to overtake the other vehicle m3 and move in front of the other vehicle m3 is determined.

For example, when the other vehicle m1 and the other vehicle m2 have been recognized at time t as shown in FIG. 6, the determiner 148 determines acceleration C (an example of the first acceleration based on the first rule) as the acceleration of the vehicle X. The action controller 146 causes the vehicle X to travel on the basis of the acceleration C. The acceleration C is, for example, greater than the acceleration A.

At time t+1, when the vehicle X has arrived at a position beyond the position P3 while moving with the acceleration C, the vehicle X determines to maintain the acceleration C (acceleration based on the first rule) if a state in which the other vehicle m2 travels immediately in front of the other vehicle m1 is maintained.

FIG. 7 is a diagram (part 2) showing an example of an action of a vehicle in the comparative example. When the vehicle X travels with the acceleration C at time t+2, the vehicle X is located behind the other vehicle m1 at time t+3. An inter-vehicle distance between the vehicle X and the other vehicle m1 is less than an inter-vehicle distance between the vehicle X and the other vehicle m1 at time t+3 after traveling with the acceleration A.

In this manner, when the inter-vehicle distance between the vehicle X and the other vehicle m1 is short, the vehicle X is easily affected by changes in the action of the other vehicle m2, the action of the other vehicle m1, or the like and the vehicle X may not be able to implement its own intended control. For example, as shown in FIG. 7, when the other vehicle m2 has stopped near the fourth area AR4 because of impossible entry into the lane L4, the other vehicle m1 may also stop behind the other vehicle m2. In this case, because the inter-vehicle distance between the vehicle X and the other vehicle m1 is short, the vehicle X may also have to stop behind the other vehicle m1.

### [Conclusion]

As described above, when the specific control is not executed, the vehicle may not be able to smoothly enter the second road R2. On the other hand, when the specific control is executed, the vehicle M can smoothly enter the second road R2.

In the above-described example, when it is predicted that the vehicle M, the other vehicle m1, and the other vehicle m2 will move to the second road R2 by passing through the third area AR3, or that the vehicle M will move to the second road R2 and the other vehicle m1 and the other vehicle m2 will move to the second road R2, in a state in which the vehicle M, the other vehicle m1, and the other vehicle m2 travels on the first road R1, it is assumed that the vehicle M tracks the other vehicle m1 with the second acceleration. Alternatively, the specific control may be executed when one or more or all of the following conditions (1) to (3) have been satisfied or when no condition has been satisfied.

Condition (1) is that the other vehicle m2 moves or is predicted to move from the first road R1 (the lane L3) to the second road R2 (the lane L4). Condition (2) is that the other vehicle m1 moves or is predicted to move from the first road R1 to the second road R2. Condition (3) is that the vehicle M moves from the first road R1 to the second road R2.

For example, when the acquirer 144 has acquired information indicating movement to the second road R2 or information regarding a route of traveling on the second road R2 from another vehicle, the action controller 146 determines that the other vehicle (the other vehicle m1 or the other vehicle m2) will move to the second road. The action controller 146 predicts that the other vehicle will move to the second road R2 when the other vehicle has taken a predetermined action. The predetermined action is that the direction indicator blinks to indicate movement to the second road R2 or that the other vehicle maintains a state in which the other vehicle is closer to the second road R2 side for a predetermined time period or longer.

[Process when Other Vehicle m2 is Absent]

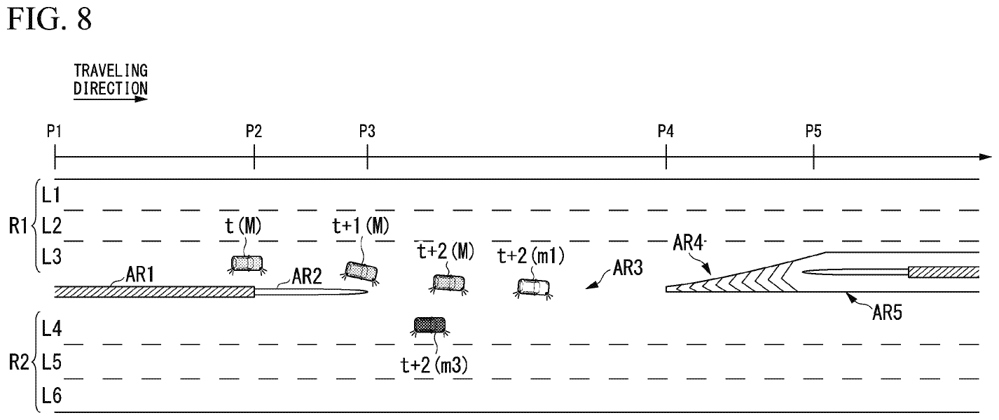

FIG. 8 is a diagram for describing a process of the vehicle M when the other vehicle m2 is absent. For example, at time t, when the other vehicle m2 is absent, the vehicle M accelerates with acceleration E (an example of the first acceleration). In this manner, when the other vehicle m2 is absent, the other vehicle m1 does not make a significant action change due to an action of a vehicle traveling immediately in front thereof. The vehicle M controls its own action in consideration of the action of the other vehicle m1, so that the vehicle M can enter the second road R2 more smoothly than when the other vehicle m2 is present.

### [Description of Acceleration]

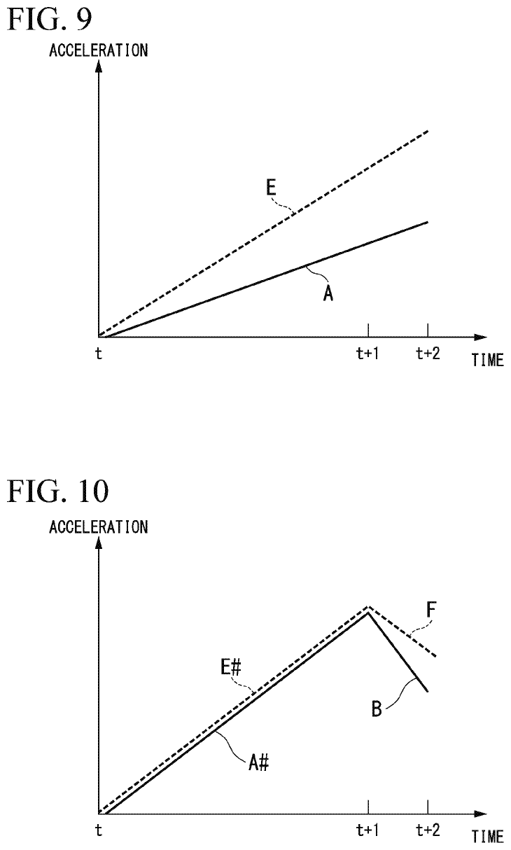

FIG. 9 is a diagram showing an example of acceleration. The vertical axis of FIG. 9 represents acceleration and the horizontal axis of FIG. 9 represents time. For example, the acceleration A and the acceleration E are positive accelerations and the acceleration A is acceleration less than the acceleration E.

FIG. 10 is a diagram showing another example of acceleration. Description similar to that of FIG. 9 will be omitted. For example, in the example of FIG. 10, during a period from time t to time t+1, the vehicle M may accelerate with acceleration A# when the vehicle M has recognized another vehicle m1 and another vehicle m2 and may accelerate with acceleration E# when the vehicle M has not recognized the other vehicle m2. The acceleration A# and the acceleration E# are equivalent accelerations. At time t+1, the vehicle M may travel with acceleration B when the vehicle M has recognized the other vehicle m1 and the other vehicle m2 and may travel with acceleration F when the vehicle M has not recognized the other vehicle m2. The acceleration B is acceleration less than the acceleration F. The acceleration B and the acceleration F are negative accelerations.

The acceleration for use in the specific control is not limited to the acceleration A, the acceleration A#, or the acceleration B described above. It is only necessary that the acceleration for use in the specific control be acceleration for which an inter-vehicle distance from the other vehicle m1 is greater than an inter-vehicle distance between the vehicle X and the other vehicle m1 in the above-described comparative example as an acceleration result. It is only necessary that the acceleration (the second acceleration) for use in the specific control be less than the acceleration (the first acceleration) used when the other vehicle m2 has not been recognized. When the acceleration (the second acceleration) for use in the specific control is less than the acceleration (the first acceleration) used when the other vehicle m2 has not been recognized, this indicates that the acceleration during a predetermined time period (a period from the above-described time t to time t+1 or time t+2 or a period from time t+1 to time t+2), an average value of accelerations, an integration value of accelerations for the predetermined time period, or the like are lower or smaller, and the trend of acceleration during the predetermined time period is gentler (than the acceleration derived according to the first rule 172).

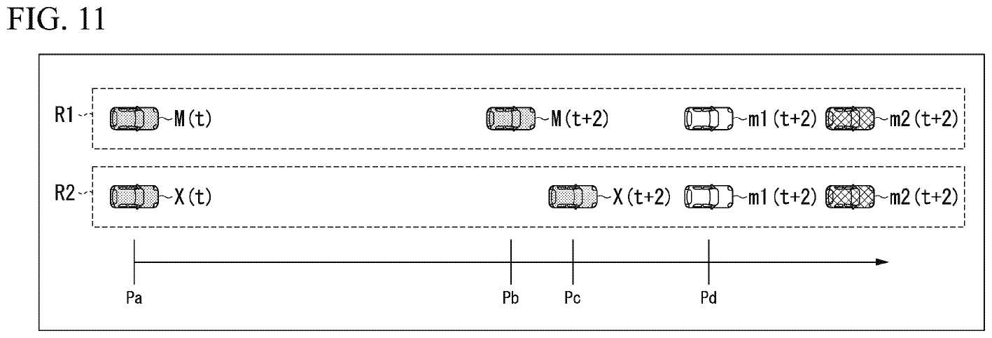

FIG. 11 is a diagram showing an example of a result R1 of executing the specific control and a result R2 of executing the process of the comparative example. For example, when the specific control has been executed, the inter-vehicle distance between the vehicle M and the other vehicle m1 at time t+2 becomes a distance between a position Pb and a position Pd. For example, when the specific control has not been executed, the inter-vehicle distance between the vehicle X and the other vehicle m1 at the time t+2 becomes a distance between a position Pc and the position Pd. In this manner, because acceleration from time t to time t+2 when the specific control has been executed is less than that when the specific control is not executed, the inter-vehicle distance at time t+2 is increased.

In the result R2 of FIG. 11, even if the other vehicle m2 has not been recognized, a similar result is obtained. This is because, when the other vehicle m2 has not been recognized, the vehicle travels with higher acceleration (the first acceleration based on the first rule) than when the specific control is executed.

### [Flowchart]

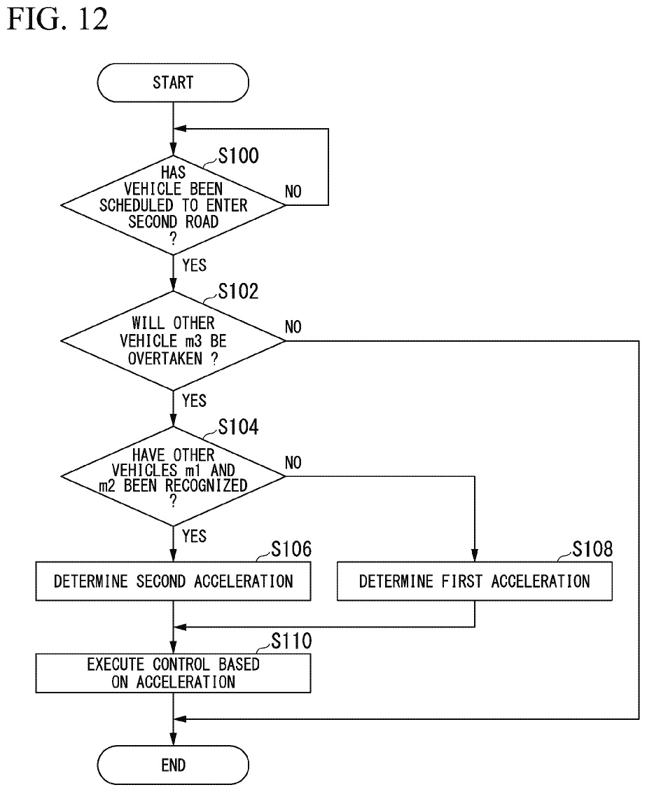

FIG. 12 is a flowchart showing an example of a flow of a process executed by the automated driving control device 100. The present process is executed, for example, if the vehicle M has reached a predetermined distance before the third area AR3 when the vehicle M moves from the first road R1 to the second road R2. The flowchart of the present process may be executed at any timing (for example, when the inter-vehicle distance between the vehicle M and the other vehicle m1 is less than or equal to a threshold value). Partial processing of the present process (for example, the processing of step S100 or S102) may be omitted.

First, the automated driving control device 100 determines whether or not the vehicle M has been scheduled to enter the second road R2 (step S100). When the vehicle M has been scheduled to enter the second road R2, the action controller 146 determines whether or not the vehicle M will overtake the other vehicle m3 traveling on the second road R2 (step S102). When the vehicle M will not overtake the other vehicle m3, the process of the present flowchart ends.

When the vehicle M will overtake the other vehicle m3, the action controller 146 determines whether or not the other vehicle m1 and the other vehicle m2 have been recognized (step S104). When the other vehicle m1 and the other vehicle m2 have been recognized, the determiner 148 determines the second acceleration based on the second rule (step S106). When either or both of the other vehicle m1 and the other vehicle m2 have not been recognized, the determiner 148 determines the first acceleration on the basis of the first rule or determines acceleration less than the second acceleration on the basis of a predetermined rule (step S108). For example, the determiner 148 may determine different accelerations as acceleration when the other vehicle m2 has not been recognized and acceleration when the other vehicle m1 and the other vehicle m2 have not been recognized. Next, the action controller 146 moves from the first road R1 to the second road R2 by controlling the vehicle M on the basis of the acceleration determined by the determiner 148 (step S110). Thereby, the process of the present flowchart end.

According to the above-described process, the automated driving control device 100 performs an appropriate acceleration operation according to a surrounding environment, so that the inter-vehicle distance between the vehicle M and the other vehicle m1 is appropriately maintained.

### [Acceleration Determination Technique]

The determiner 148 determines acceleration on the basis of, for example, the concepts of the following Eqs. (1) to (5). A rule based on these concepts is an example of the “second rule.” For example, the second rule 174 is a rule for determining corrected acceleration as the second acceleration (acceleration a) by performing correction for curbing the first acceleration on the basis of an amount of change (for example, (X#−X) or (V#−V)) in a speed or acceleration of the vehicle M during a predetermined time period in which the vehicle M has traveled with the first acceleration (acceleration a#).

a=a#−k1(X#−X) Eq. (1)

“a” is acceleration (the acceleration A, the acceleration A#, the acceleration B, or the like) for use in specific control. “a#” is acceleration derived when the determiner 148 provides the feedback of a current inter-vehicle distance according to the first rule 172 (for example, a predetermined model) so that the inter-vehicle distance between the vehicle M and the other vehicle m1 becomes an appropriate inter-vehicle distance. “a#” is acceleration set on the basis of the other vehicle m1 when the other vehicle m2 has not been recognized. The acceleration a# is determined with reference to a preset map or table. For example, the inter-vehicle distance between the other vehicle m1 and the vehicle M and the speeds (or accelerations) of the vehicle M and the other vehicle m1 are parameters when the acceleration a# is determined. The acceleration a is an example of the second acceleration derived according to the second rule 174 and the acceleration a# is an example of the second acceleration derived according to the first rule 172.

For example, the determiner 148 may determine acceleration using an amount of displacement of a position of the vehicle M in the future. “k1” is a preset coefficient. “k1” may be a fixed value or a value that changes with a speed or acceleration of the vehicle M or the other vehicle m1 or an inter-vehicle distance therebetween. “X” is a current position of the vehicle M. “X#” is a future position of the vehicle M. “X#” is a position where it is estimated that the position of the vehicle M will be appropriate in the future. “X#” is a position set on the basis of an appropriate inter-vehicle distance between the vehicle M and the other vehicle m1. “X#” is a position set on the basis of either or both of the speed of the vehicle M and the speed of the other vehicle m1. As in Eq. (1), the determiner 148 may determine acceleration using the acceleration when the other vehicle m2 has not been recognized and an amount of displacement of a position of the vehicle M.

As in Eq. (2), the determiner 148 may determine acceleration using an amount of displacement of a position of the vehicle M. “k2” is a preset coefficient. “k2” may be a fixed value or a value that changes with a speed or acceleration of the vehicle M or the other vehicle m1 or an inter-vehicle distance therebetween.

a=k2(X#−X) Eq. (2)

For example, the determiner 148 may determine acceleration using an amount of displacement of a speed (or acceleration) of the vehicle M in the future. “k3” is a preset coefficient. “k3” may be a fixed value or a value that changes with a speed or acceleration of the vehicle M or the other vehicle m1 or an inter-vehicle distance therebetween. “V” is a current speed of the vehicle M. “V#” is a speed of the vehicle M after a predetermined time period. “V#” is a speed set on the basis of a speed of the other vehicle m1 and/or an inter-vehicle distance between the vehicle M and the other vehicle m1. The current acceleration of the vehicle M may be used instead of “V” and the future acceleration of the vehicle M may be used instead of “V#.” As in Eq. (3), the determiner 148 may determine acceleration using the acceleration when the other vehicle m2 has not been recognized and the amount of displacement of the speed (or acceleration) of the vehicle M.

a=a#−k3(V#−V) Eq. (3)

As in Eq. (4), the determiner 148 may determine acceleration using the amount of displacement of the speed (or acceleration) of the vehicle M. “k4” is a preset coefficient. “k4” may be a fixed value or a value that changes with a speed or acceleration of the vehicle M or the other vehicle m1 or an inter-vehicle distance therebetween.

a=k4(V#−V) Eq. (4)

As in Eq. (5), the determiner 148 may determine acceleration using an amount of displacement of a position of the vehicle M in the future and an amount of displacement of a speed (or acceleration) of the vehicle M in the future.

a=a#−k1(X#−X)−k2(V#−V) Eq. (5)

The determiner 148 may determine the acceleration of the vehicle M on the basis of a set upper limit value. For example, when the acceleration a# exceeds the upper limit value, the determiner 148 may correct the acceleration a# to acceleration of the upper limit value or less.

The determiner 148 may adopt acceleration determined according to a different technique for each predetermined time. For example, the determiner 148 may determine the acceleration using Eq. (1) with respect to the acceleration A and determine the acceleration using Eq. (3) with respect to the acceleration B. For example, the determiner 148 may adopt the acceleration a# for the acceleration A and adopt acceleration determined using Eq. (5) for the acceleration B.

For example, the action controller 146 generates an action plan on the basis of a surrounding situation of the vehicle M including the other vehicle m1 (or including the other vehicle m1 without including the other vehicle m2). This action plan includes a course and acceleration of the vehicle M and the like. For example, the determiner 148 adopts the acceleration (for example, the acceleration a#) of the action plan when the other vehicle m1 and the other vehicle m2 have not been recognized and adopts corrected acceleration (for example, the acceleration a) by correcting the acceleration of the action plan on the basis of the above-described concept when the other vehicle m1 and the other vehicle m2 have been recognized. The action controller 146 generates a target trajectory on the basis of the action plan with the adopted acceleration and controls the vehicle M on the basis of the generated target trajectory.

As described above, the determiner 148 can implement control of the vehicle M according to a surrounding environment by determining acceleration using an amount of displacement of a position of the vehicle M, an amount of displacement of a speed of the vehicle M, and an amount of displacement of acceleration of the vehicle M.

According to the first embodiment described above, the automated driving control device 100 can implement appropriate control of a vehicle according to a surrounding environment by causing the vehicle M to track the other vehicle m1 with the second acceleration derived according to the second rule 174 when the other vehicle m1 has been recognized and the other vehicle m2 has been recognized.

### Second Embodiment

A second embodiment will be described below. In the first embodiment, a case in which the vehicle M executes automated driving has been described. In the second embodiment, driving assistance control of the vehicle M is executed. In the following, differences of the second embodiment from the first embodiment will be described.

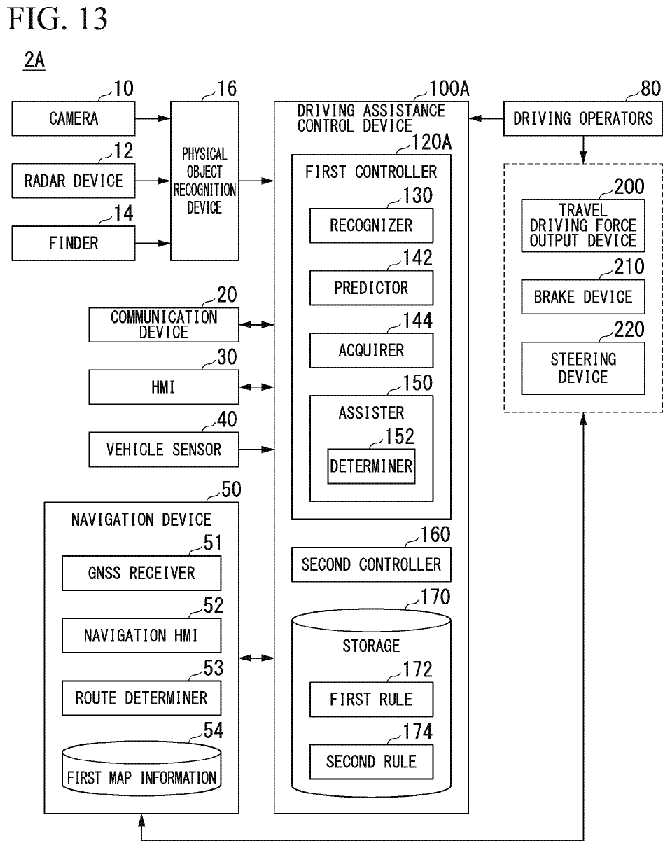

FIG. 13 is a diagram showing an example of a functional configuration of a vehicle system 2A according to the second embodiment. The vehicle system 2A includes a driving assistance control device 100A instead of the automated driving control device 100 of the vehicle system 2. The MPU 60 is omitted from the vehicle system 2A.

The driving assistance control device 100A includes, for example, a first controller 120A, a second controller 160, and a storage 170. The first controller 120A includes, for example, a recognizer 130, a predictor 142, an acquirer 144, and an assister 150. A functional configuration of the recognizer 130, the predictor 142, and the acquirer 144 is similar to that of the recognizer 130, the predictor 142, and the acquirer 144 of the first embodiment. The assister 150 includes, for example, a determiner 152. The determiner 152 determines acceleration of a vehicle M. For example, the assister 150 controls the vehicle M on the basis of the acceleration determined by the determiner 152. For example, the assister 150 controls the vehicle M so that an inter-vehicle distance between a preceding vehicle and the vehicle M is maintained at an appropriate inter-vehicle distance. The assister 150 is a functional unit that implements so-called adaptive cruise control (ACC). A functional configuration of the second controller 160 and the storage 170 is similar to that of the second controller 160 and the storage 170 of the first embodiment.

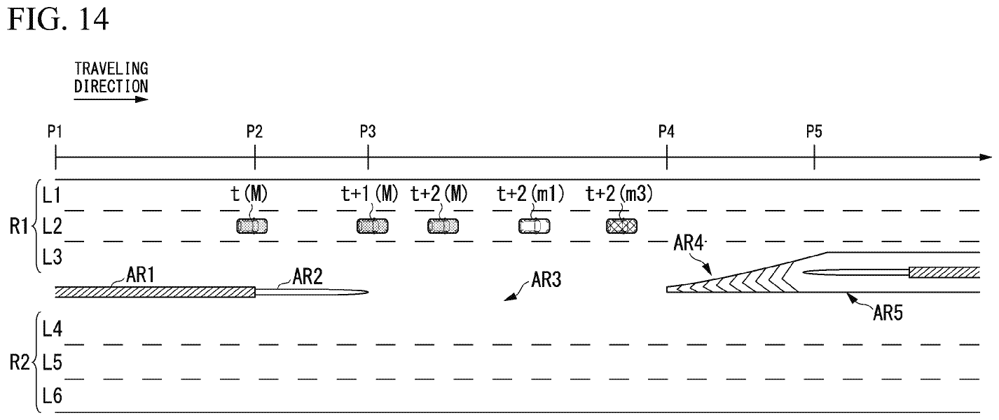

FIG. 14 is a diagram for describing control of the vehicle M according to the second embodiment. For example, it is assumed that the vehicle M, another vehicle m1, and another vehicle m2 travel in a lane L2 and then travel in the lane L2 as they are. When the vehicle M has recognized the other vehicle m1 and the other vehicle m2 at time t and time t+1, the vehicle M accelerates with second acceleration. Thereby, at time t+2, the vehicle M maintains an appropriate inter-vehicle distance from the other vehicle m1. The inter-vehicle distance is longer than an inter-vehicle distance between the vehicle M and the other vehicle m1 when the other vehicle m2 is absent.

As described above, the determiner 152 can determine acceleration in consideration of a change in an action of the other vehicle m2 and the assister 150 can appropriately maintain the inter-vehicle distance from the other vehicle m1 by controlling the vehicle M on the basis of the determined second acceleration even if an action of the other vehicle m1 has changed due to the action of the other vehicle m2.

According to the second embodiment described above, the assister 150 can implement appropriate vehicle control according to a surrounding environment on the basis of the second acceleration determined by the determiner 152.

### Modified Example

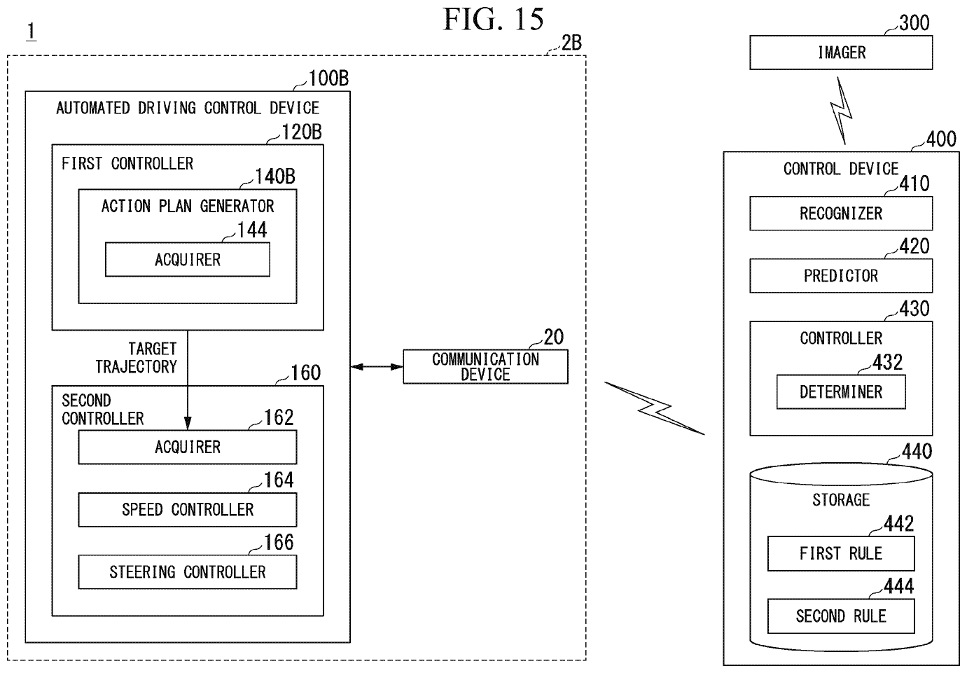

A part or all of the functional configuration included in the automated driving control device 100 may be provided in another device. For example, a remote operation on a vehicle M may be executed by a functional configuration shown in FIG. 15. FIG. 15 is a diagram showing an example of a functional configuration of a vehicle control system 1. The vehicle control system 1 includes, for example, a vehicle system 2B, an imager 300, and a control device 400. The vehicle system 2B communicates with the control device 400 and the imager 300 communicates with the control device 400. The vehicle system 2B and the control device 400 communicate with each other to transmit or receive information necessary for the vehicle M to automatedly travel on a first road R1 or a second road R2.

The imager 300 is a camera that captures an image of the vicinity of a merge location where the first road R1 and the second road R2 shown in FIG. 3 or the like meet. The imager 300 images, for example, the vicinity of the merge location in an overhead direction. Although the example of FIG. 15 shows one imager 300, the vehicle control system 1 may include a plurality of imagers 300.

The vehicle system 2B includes an automated driving control device 100B instead of the automated driving control device 100. The illustration of a functional configuration other than the automated driving control device 100B and the communication device 20 is omitted from FIG. 15. The automated driving control device 100B includes a first controller 120B and a second controller 160. The first controller 120B includes an action plan generator 140B. For example, the action plan generator 140B includes an acquirer 144.

The control device 400 includes, for example, a recognizer 410, a predictor 420, a controller 430, and a storage 440. The storage 440 stores a first rule 442 and a second rule 444. Information of the first rule 442 and the second rule 444 is similar to that of the first rule 172 and the second rule 174. The recognizer 410 recognizes vehicles near the first road R1 and the second road R2, lanes, physical objects required to be recognized when the vehicle M travels, indications, and the like from the image captured by the imager 300 on the basis of pattern matching, deep learning, and other image processing techniques. For example, a function of the recognizer 410 is equivalent to that of the recognizer 130. A function of the predictor 420 is equivalent to that of the predictor 142.

The controller 430 includes a determiner 432. A function of the determiner 432 is equivalent to that of the determiner 148 of the first embodiment. The controller 430 travels in a recommended lane generally determined by the recommended lane determiner 61 (a recommended lane which is information transmitted to the vehicle M) and further automatedly generates a target trajectory along which the vehicle M will automatedly travel in the future so that it is possible to cope with a surrounding environment of the host vehicle M. As described in each of the above-described embodiments, the controller 430 generates a target trajectory on the basis of a control result by performing specific control when the target trajectory is generated. The automated driving control device 100B causes the vehicle M to travel on the basis of the target trajectory transmitted by the control device 400.

According to the embodiment of the modified example described above, the vehicle control system 1 has effects similar to those of the first embodiment. The embodiment of the modified example described above may be applied to the second embodiment. In this case, the driving assistance control device 100A can maintain an inter-vehicle distance between the vehicle M and the other vehicle m1 at an appropriate distance by controlling the vehicle M with the second acceleration determined by the control device 400.

### [Hardware Configuration]

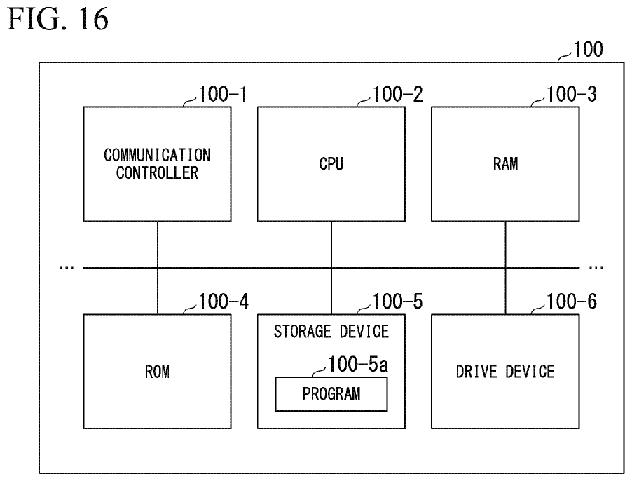

FIG. 16 is a diagram showing an example of a hardware configuration of the automated driving control device 100 according to the embodiment. As shown in FIG. 16, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or an HDD, a drive device 100-6, and the like are mutually connected by an internal bus or a dedicated communication line. The communication controller 100-1 communicates with components other than the automated driving control device 100. The storage device 100-5 stores a program 100-5a to be executed by the CPU 100-2. This program is loaded into the RAM 100-3 by a direct memory access (DMA) controller (not shown) or the like and executed by the CPU 100-2. Thereby, either or both of the recognizer 130 and the action plan generator 140 are implemented.

The above-described embodiment can be implemented as follows.

A vehicle control device including:

a storage device storing a program; and

a hardware processor,

wherein the hardware processor executes the program stored in the storage device to:

acquire a recognition result of a recognizer for recognizing surroundings of a vehicle;

control an action of the vehicle;

when the recognition result represents that a first vehicle traveling immediately in front of the vehicle has been recognized and a second vehicle traveling immediately in front of the first vehicle has not been recognized, perform a process of causing the vehicle to track the first vehicle with first acceleration derived in a first rule; and

when the recognition result represents that the first vehicle and the second vehicle have been recognized, perform a process of causing the vehicle to track the first vehicle with second acceleration derived in a second rule,

wherein the second rule is a rule for deriving acceleration less than that in the first rule when a relative relationship between the vehicle and the first vehicle is uniform.

Although modes for carrying out the present invention have been described using embodiments, the present invention is not limited to the embodiments and various modifications and substitutions can also be made without departing from the scope and spirit of the present invention.

What is claimed is:

1. A vehicle control device comprising:
an acquirer configured to acquire a recognition result of a recognizer for recognizing surroundings of a vehicle; and
an action controller configured to control an action of the vehicle,
wherein, when the recognition result represents that a first vehicle traveling immediately in front of the vehicle has been recognized and a second vehicle traveling immediately in front of the first vehicle has not been recognized, the action controller causes the vehicle to track the first vehicle with first acceleration derived in a first rule,
wherein, when the recognition result represents that the first vehicle and the second vehicle have been recognized, the action controller causes the vehicle to track the first vehicle with second acceleration derived in a second rule, and
wherein the second rule is a rule for deriving acceleration less than that in the first rule when a relative relationship between the vehicle and the first vehicle is uniform.

2. The vehicle control device according to claim 1, wherein the relative relationship includes an inter-vehicle distance between the vehicle and the first vehicle and relative speeds of the vehicle and the first vehicle.

3. The vehicle control device according to claim 1, wherein, when the recognition result represents that the first vehicle and the second vehicle have been recognized and when the recognition result represents that the second vehicle has moved from a first road on which the vehicle is traveling to a second road adjacent to the first road or when it is predicted that the second vehicle will move from the first road to the second road on the basis of the recognition result, the action controller causes the vehicle to track the first vehicle with the second acceleration.

4. The vehicle control device according to claim 1, wherein, when the recognition result represents that the first vehicle has moved from a first road on which the vehicle is traveling to a second road adjacent to the first road or it is predicted that the first vehicle will move from the first road to the second road on the basis of the recognition result, the action controller causes the vehicle to track the first vehicle with the second acceleration.

5. The vehicle control device according to claim 3, wherein the action controller predicts a movement direction of the first vehicle or the second vehicle on the basis of an ON state of a direction indicator of the first vehicle or the second vehicle and determines acceleration of the vehicle on the basis of a prediction result.

6. The vehicle control device according to claim 1, wherein, when the recognition result represents that the first vehicle has been recognized and the second vehicle has not been recognized if the vehicle moves from a first road on which the vehicle is traveling to a second road adjacent to the first road, the action controller causes the vehicle to track the first vehicle with the second acceleration.

7. The vehicle control device according to claim 1,
wherein a first specific area through which vehicles cannot pass, a second specific area through which the vehicles can pass, and a third specific area through which the vehicles cannot pass provided between a first road and a second road adjacent to the first road in a width direction are provided in that order in a road extension direction, the vehicle traveling on the first road can travel on the second road by passing through the first specific area and the second specific area, and the vehicle traveling on the second road can travel on the first road by passing through the first specific area and the second specific area, and
wherein the action controller causes the vehicle to track the first vehicle with the second acceleration when it is predicted that the vehicle, the first vehicle, and the second vehicle will move to the second road by passing through the second specific area, or that the vehicle will move to the second road and the first vehicle and the second vehicle will move to the second road, in a state in which the vehicle, the first vehicle, and the second vehicle are traveling on the first road with reference to the recognition result.

8. The vehicle control device according to claim 1, wherein the second rule is a rule for determining corrected acceleration as the second acceleration by performing correction for curbing the first acceleration on the basis of an amount of change in a speed or acceleration of the vehicle during a predetermined time period in which the vehicle has traveled with the first acceleration.

9. A vehicle control device comprising:
an acquirer configured to acquire a recognition result of a recognizer for recognizing surroundings of a vehicle; and
an action controller configured to control an action of the vehicle,
wherein, when the recognition result represents that a first vehicle traveling immediately in front of the vehicle has been recognized and a second vehicle traveling immediately in front of the first vehicle has not been recognized, the action controller controls the vehicle on the basis of first acceleration derived in a first rule,
wherein, when the recognition result represents that the first vehicle and the second vehicle have been recognized, the action controller controls the vehicle on the basis of second acceleration derived in a second rule, and
wherein the second rule is a rule for deriving the second acceleration less than the first acceleration derived in the first rule on the basis of an amount of change in a speed or acceleration of the vehicle during a predetermined time period in which the vehicle has traveled with the first acceleration.

10. A vehicle control method comprising:
acquiring, by a computer, a recognition result of a recognizer for recognizing surroundings of a vehicle;
controlling, by the computer, an action of the vehicle;
when the recognition result represents that a first vehicle traveling immediately in front of the vehicle has been recognized and a second vehicle traveling immediately in front of the first vehicle has not been recognized, causing, by the computer, the vehicle to track the first vehicle with first acceleration derived in a first rule; and
when the recognition result represents that the first vehicle and the second vehicle have been recognized, causing, by the computer, the vehicle to track the first vehicle with second acceleration derived in a second rule,
wherein the second rule is a rule for deriving acceleration less than that in the first rule when a relative relationship between the vehicle and the first vehicle is uniform.

11. A computer-readable non-transitory storage medium storing a program for causing a computer to:
acquire a recognition result of a recognizer for recognizing surroundings of a vehicle;
control an action of the vehicle;
when the recognition result represents that a first vehicle traveling immediately in front of the vehicle has been recognized and a second vehicle traveling immediately in front of the first vehicle has not been recognized, perform a process of causing the vehicle to track the first vehicle with first acceleration derived in a first rule; and
when the recognition result represents that the first vehicle and the second vehicle have been recognized, perform a process of causing the vehicle to track the first vehicle with second acceleration derived in a second rule,
wherein the second rule is a rule for deriving acceleration less than that in the first rule when a relative relationship between the vehicle and the first vehicle is uniform.
